(19) United States
(12) Patent Application Publication
(10) Pub. No.: US 2002/0064756 A1
(43) Pub. Date: May 30, 2002

(54) Dental handpiece for forming root canals

(75) Inventors: Mauro Pagnini, Pistoia (IT); Daniele Poli, Pistoia (IT); Mauro Romagnani, Pistoia (IT)

Correspondence Address: BROWDY AND NEIMARK, P.L.L.C., 624 NINTH STREET, NW, SUITE 300, WASHINGTON, DC, 20001-5303, US

(73) Assignee: ADVANCED TECHNOLOGY RESEARCH (A.T.R.), Pistola (IT)

(21) Appl. No.: 09/996,875

(22) Filed: Nov. 30, 2001

(30) Foreign Application Priority Data
Nov. 30, 2000 (IT) FI2000A000241

(51) Int. Cl. A61C 5/02

(52) U.S. Cl. 433/102

(57) ABSTRACT

A dental handpiece for forming root canals comprising a motor, a cutting tool driven by said motor, and control means for automatically and periodically reversing the motor according to preset rotation periods of the tool in one direction and in the opposite one, respectively. Preferably, the preset rotation periods are each and independently selected in the range of 0.05 to 2.50 sec. Means for detecting the load torque applied to the tool may also be enabled, so that the control means reverse said motor when the torque detected by the load torque detection means reaches a preset reference value, the control means also triggering an acoustic signal when the detected load torque enters a neighborhood of the preset reference torque.

### FIELD OF THE INVENTION

The present invention relates to the field of endodontics and, more precisely, to that of the dental handpieces which are used to cut tooth. In particular, the invention refers to a dental handpiece for forming root canals.

### BACKGROUND OF THE INVENTION

In cutting handpieces used in endodontics, a cutting tool is driven by a motor, usually a miniaturized electric micromotor powered by direct or alternate current and controlled by a CPU control system.

The control system is charged with the function of adjusting the operation of the motor in order to obtain, as precisely as possible, the required cutting speed. Besides, the breakage of the cutting tool—always possible especially with slender tools—must be avoided. The possibility of a breakage increases with the rotation speed of the tool, and the load torque applied thereto. Therefore, both these parameters must be controlled.

The rotation speed control is usually carried out with analogic techniques, based upon the measurement of a voltage which is proportional to such speed. In fact, digital systems making use of an encoder with the appropriate circuitry for reading and processing the output pulses thereof, are at present discarded, due to the fact that they require supplementary mechanisms added to the motor, with an intolerable increase of the overall size of the handpiece.

The load torque is controlled by detecting the current flowing through the motor in an analogical way, i.e. letting the current flow in a suitably chosen resistance and measuring the voltage across it. The output value is then compared with a preset reference value, the overcoming of which involves too high a risk of breaking the tool.

Namely, in a known solution, when the reference value is reached, a signal reverses the motor, and thus the rotation of the tool. However, a noteworthy problem arises in such a type of control.

In fact, the abrupt reversal of the rotation of the tool when the load torque—being around the reference value—is high, causes a remarkable stress which, being repeated in time, may cause a fatigue breakage, especially when certain kinds of tools are used. Such stress is the more remarkable the longer is the time passing from the reaching of the reference torque and the actual reversal of the motor. During said time, while the motor is still working, and consequently the spindle end of the tool is driven, the tip thereof is most likely jammed in the dental root canal, this resulting in a considerable torsional stress.

Moreover, it has to be emphasized that with several kind of tools, especially when used for forming warped canals, the prolonged operation in a single direction, even far from theoretically dangerous load torque values, the incidence breakage phenomena is all but insignificant.

### SUMMARY OF THE INVENTION

The object of the present invention is to solve the above mentioned problem, by providing a dental handpiece in which the control of the tool-driving motor makes it possible, taking into consideration the specific circumstances of use, to minimize the risks of a breakage of the tool due either to a reversal of direction of rotation in a high load torque condition, or to a prolonged operation in a single direction.

Such object is achieved with the dental handpiece for forming root canals comprising a motor, a cutting tool driven by said motor, and control means for automatically and periodically reversing the motor according to preset rotation periods of said tool in one direction and in the opposite one, respectively. Preferably, the preset rotation periods are each and independently selected in the range of 0.05 to 2.50 sec.

According to a further aspect of the invention, means for detecting the load torque applied to the tool may be enabled, so that the control means reverse said motor when the torque detected by the load torque detection means reaches a preset reference value, the control means also triggering an acoustic signal when the detected load torque enters a neighborhood of the preset reference torque.

### BRIEF DESCRIPTION OF THE DRAWINGS

The features and advantages of the dental handpiece for forming root canals according to the present invention will be made clearer with the following description of an embodiment thereof, made purely by way of example and not limitative, with reference to the attached drawings in which:

FIG. 1 is a flowchart elucidating the motor control procedure without load torque detection, carried out in the handpiece according to the invention;

FIG. 2 is a flowchart schematically elucidating the motor control procedure with load torque detection, carried out in the handpiece according to the invention;

FIG. 3 is a schematic circuit diagram of a dental handpiece according to the invention.

### DETAILED DESCRIPTION OF THE PREFERRED EMBODIMENT

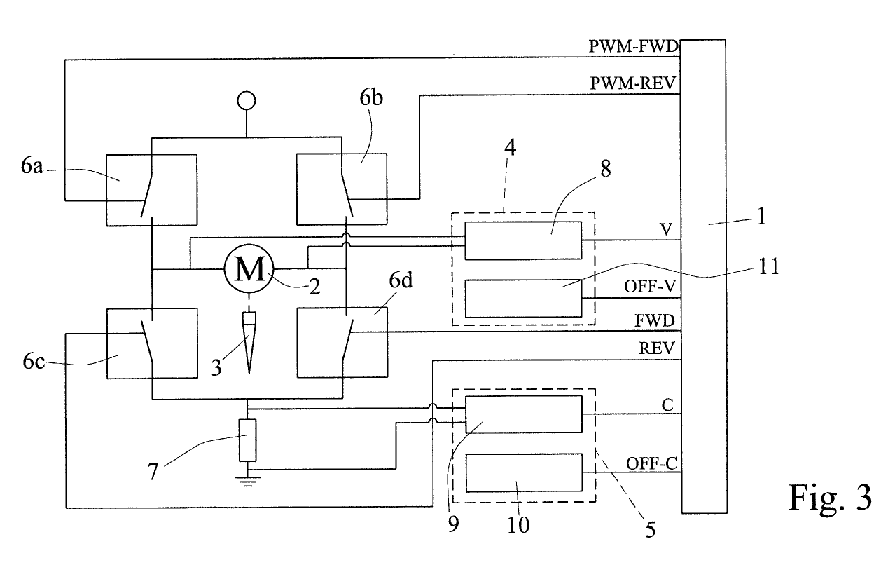

With reference to FIG. 3, an endodontic handpiece is represented by means of a schematic circuit diagram. Only the essential components of the device are shown, everything not specifically detailed being correspondent to the devices of the background art. In such diagram, a cutting tool 3 is shown, driven by a miniaturized DC electric motor 3, controlled by a CPU 1. Means for detecting the rotation speed of tool 3 and for detecting the load torque applied thereto are indicated, respectively, at 4 and 5. The construction of such means, as such, must be assumed as known to the skilled person. The operation of motor 2 is controlled by the CPU 1 via PWM signals, in response to output signals of speed and load torque detection means 4 and 5. The diagram shows also a connection circuitry, described more in detail hereinafter, omitting the electric power supply line which, controlled by unit 1, makes motor 2 work.

Besides carrying out the control process that has been referred to in the introductory part—i.e. that providing the reversal of motor 2 when the load torque applied to tool 3 has reached a preset reference torque—according to the invention the handpiece may use a different control procedure, not making use of the detection of the load torque applied to tool 3.

In such procedure, after disabling the torque detection means 5, motor 2 and consequently tool 3 operate in a reciprocating manner, with preset rotation periods TF and TR in the two directions, respectively. The forward and reverse operation periods are preferably selected between values spaced by 0.1 sec, in the range of 0.05 to 2.50 sec.

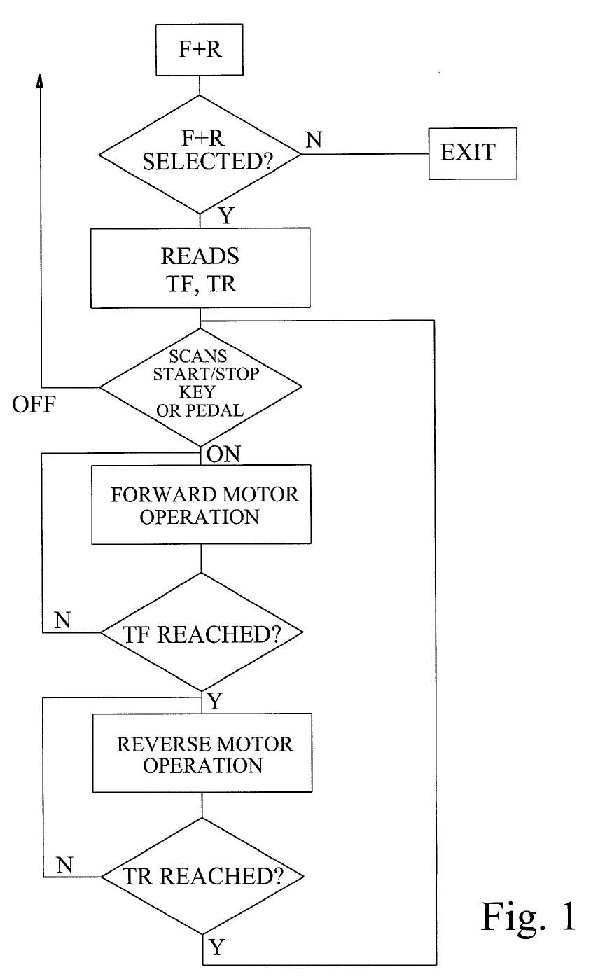

Referring also to FIG. 1, when such a control (indicated at F+R) is selected and enabled, the software resident in the CPU 1 reads the preset reference values TF and TR and takes a standby condition, awaiting the start of the motor, commanded by the medical operator via a key or a pedal associated to the handpiece. The start is promptly detected by unit 1 which, in said standby condition, constantly scans the start/stop key or pedal acting on the power supply to the motor.

As the motor is started, a timer integrated in the CPU is turned on, for checking the reaching of TF. Period TF being lapsed, motor 2 is reversed and the timer is reset, so that the rotation period TR in the opposite direction can be checked. CPU 1, as the timer runs, keeps on scanning the start/stop key or pedal, whereby motor 2 can be immediately stopped by the operator, without awaiting the fulfillment of a forward or reverse period.

As mentioned, during the F+R control, neither the load torque nor the speed are detected. As to the speed, motor 2 is reversed at a very fast pace, and therefore is always in a transient state, with operating features which are very far from the standard ones and thus are not significant. Besides, in the F+R operation, tool 3 is not subject to any torsion, because the reversal of the motion occurs well before that the same tool may be jammed in the dental root canal.

The F+R control procedure is advantageously chosen when—obviously—a tool suitable for working in both the directions of rotation is used and whenever the traditional reference torque reaching control is risky as regards the possibility of a breakage of the tool. Besides, the opportunity of freely and independently setting the periods of the forward and reverse rotation makes the handpiece suitable for the research and design of new kind of tools, which may take advantage of this different working system.

When, to the contrary, the traditional load detection control is selected, the present invention provides for a further advantageous aspect, still related to the problem of the reversal of direction of rotation in a high load torque condition. In fact, the medical operator is warned, via an acoustic signal, that the load torque is approaching the preset reference value, and therefore that the reversal of the rotation is about to occur. As a consequence of the warning signal, the operator may act so as to reduce the load torque, thus avoiding the reversal of the rotation and the resulting stress affecting the tool.

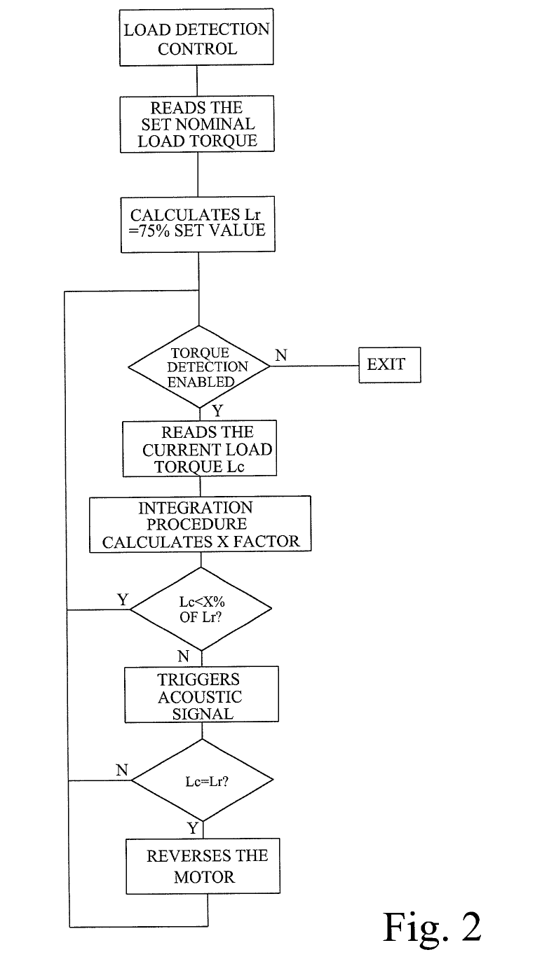

According to such further aspect of the invention, the operator is not merely warned of the upcoming reversal, but is also informed of the way such event is approached. In greater detail, referring to the flowchart of FIG. 2, when the torque detection control procedure is adopted, a value is set, corresponding to the nominal maximum load torque which is bearable by the tool. Preferably, the operator chooses among a number (e.g. 100) of prearranged values.

Once read such value, the software resident in the CPU 1 calculates the reference load torque Lr in correspondence to which motor 2, and consequently tool 3, must be reversed. Such reference value is preferably fixed as a 75% of the nominal preset value.

Then, in each cycle of the PMW signal which controls motor 2, the following routine is executed. Preliminarily, it is checked that the load torque detection control is actually enabled. Afterwards, the current load torque value detected by detection means 5 is read. Such value is compared with the values acquired in the previous cycles, thereby obtaining the growth rate, with an integration procedure carried out by means of a digital filter.

A percentage factor X is obtained as a function of the detected torque value and of the growth rate. If the detected torque exceeds an X% of the reference value Lr, an intermittent acoustic signal is emitted, with pulses which are the more frequent, the more persistently the detected torque keeps itself about the reference value. Nevertheless, the operator may choose to disregard the warning signal, and await the reversal of the rotation. Thus, the decision on the way to proceed is made by the operator who may also turn the sound off with an appropriate command.

In further detail, in each cycle of the PMW signal the detected, current load torque Lc is subtracted from the torque Lp detected in the previous cycle. Given the three possibilities Lc<Lp, Lc=Lp and Lc>Lp, a variable Va—to be used for a comparison with the reference load torque value Lr—is, respectively, reduced, kept unchanged or increased. The reduction/increase ratio is fixed, so that the noise resulting from possible peak-variations of the load torque can be disregarded. As mentioned, the load torque value Lc is detected in each period of the PWM signal cycle, thereby, in standard conditions, a detection occurs every 6/1000 of a revolution of the tool (this being the rotation carried out in a period).

When a neighborhood of Lr is entered, the extent of such neighborhood being established by factor X, a low-frequency signal is emitted. On the other hand, if value Lr is occasionally exceeded, the frequency increases, proportionally to the frequency with which the such overcoming occurs. When the detected load torque is steadily above Lr, a high-frequency signal is obtained. Finally, if the detected value exceeds Lr for longer than 150 msec, motor 2 is reversed. This occurrence is revealed by the emission of an acoustic signal of a predetermined low frequency.

The analysis of graphs showing the evolution of the load torque as a function of time during an operation in the dental root canal, show 7-8 oscillations in a 10 second period, with slopes comprised between 4 and 10 nMm/sec. Such evolution is due to the reciprocating axial motion that the operator gives to the tool, making it slide along the dental root canal. This motion, which in the prior art could only rely on the skill and experience of the operator, is now guided by the handpiece, which warns the same operator to draw the tool back when the reference torque is approached.

The control speed provided by CPU 1 would be seriously affected by its association to actuating means comprising one or more common relays (operating time >10 msec), as presently in use in the known art. For this reason, in the handpiece according to the present invention the motor is controlled via a MOSFET bridge, allowing a response time of 1 msec without, in practice, any limitation as to life and number of switchovers.

In this way, the feedback of the system has a much reduced overshoot in comparison with the traditional systems. For the sake of clarity, it must be noticed that the overcoming of the reference load torque is detected in a very short time, in the order of some microseconds. The same can be said of the time for processing the signal and for sending the reversal command to the motor. The critical time is therefore chiefly the time concerned with the response of the electromechanical actuator (>10 msec for a relay). During said time, the tip of the cutting tool may be jammed in the dental root canal, whereas the opposite end, mechanically coupled to the motor, continues its rotation, carrying out an angular displacement up to 180° or even greater. Of course, this situation causes a very dangerous torsion of the tool. If the response time is cut down to few tens of microseconds, the extent of such torsion is proportionally reduced. This goal is achieved, as mentioned, by making use of a MOSFET bridge, and also of an electric motor of the Faulhaber® type (ensuring a very short response time as well).

Turning back to the circuit diagram of FIG. 3, in a dental handpiece according to the invention motor 2 is arranged between four legs 6a, 6b, 6c and 6d of a MOSFET bridge, controlled by CPU 1 so that the power supply current flows through the same motor 2 one way or the other. More precisely, the upper legs of the bridge are controlled by the PWD-FWD and PWD-REV signals (forward and reverse rotation, respectively). The lower legs are controlled by FWD and REV signals, and are earthed via a low-value resistor 7, from which the feedback signal for the load torque detection by the means 5 is obtained. Detection means 5 comprise a differential amplifier 9 and an offset adder 10, and cooperate with an ADC (Analog to Digital Converter) embodied in CPU unit 1.

The terminals of motor 2 are connected to the speed detection means 4, and more precisely to the input of a differential amplifier 8, associated to an offset adder 11. Also in this case, a cooperation with an ADC embodied in CPU unit 1 is established.

N-channel and p-channel MOSFETs 6, 6b, 6c and 6d receive the control signal from CPU 1 via a buffer and a control logic stored in a GAL which, in order to avoid the simultaneous conduction of wrong legs of the bridge—and thus the short-circuit of the legs or the by-passing of the motor—makes the same legs open and close according to a predetermined protocol. Low capacitance condensers and zener diodes protect the circuit from high-voltage fast transients.

The above described hardware configuration is controlled by the software resident in CPU 1, which computes the values to be supplied to the inputs in each period of the PWM signal cycle, both for a forward and a reverse motion, as a function of the detected load torque and speed. This obviously does not apply to the F+R control procedure, and also to the first 5 msec of working (initial transient) so that the motor can gain speed. As to the load torque detection means 5, in order to exploit the whole dynamic range of the relevant ADC, the software carries out an integration over a whole PWM period, the value so obtained being used for adjusting the offset of differential amplifier 9 so as to maintain a setting of +/−128 steps.

When motor 2 is in FWD motion, legs 6a and 6d are in conduction, so that the current flows from left to right. At the end of the PWM duty cycle, leg 6a is blocked; in some tens of msec, leg 6d is blocked too. In each subsequent cycle, leg 6d first and leg 6a afterwards are set in conduction, if the motion is in the FWD mode. To the contrary, if the motion is in the REV mode, leg 6c first and leg 6b afterwards are set in conduction. During the PWM phase in which the output is low, motor 2 is free and acts as a generator, producing a voltage which is proportional to the speed.

This voltage is applied to the inputs of differential amplifier 8 and is added via adder 11 to the offset signal coming from CPU 1. The output voltage of amplifier 8 is read by the ADC about 30 μs after the PWM has attained the low level. CPU 1 recognizes the working mode of motor 2 and thus is able to assess whether the motor has to be over or under powered, in the forward or the reverse operation, thereby evaluating the subsequent duty cycle of the PWM.

The voltage measured across resistance 7 is integrated via amplifier 9 and added via adder 10 to the offset signal from CPU 1, said signal resulting from an estimate carried out for taking into account the inertia of the device. The algorithm used to this latter purpose makes the offset signal insensitive to variation of the power supply comprised between +/−15%. Furthermore, the algorithm is such that motor 2 is reversed the more promptly (in a range comprised between 4÷5 and 40÷50 msec), the more rapidly the reference load torque Lr is approached.

Both the software in EEPROM and the control logic in the GAL are protected against the copy. Namely, the boot in the first page of the EEPROM is protected against accidental erasures. The remaining storage area can be reprogrammed via a RS232 serial communication.

It will be appreciated from what described above that the invention involves a number of remarkable advantages with respect to the prior art, said advantages deriving from a reduced likelihood of tool breakage and, more generally speaking, from a finer and more accurate control of the cutting operations, resulting in a faster and better-quality work.

Variations and/or modifications can be brought to the dental handpiece for forming root canals according to the present invention without departing from the scope of the invention itself as defined in the appended claims.

1. A dental handpiece for forming root canals comprising a motor, a cutting tool driven by said motor, and control means for automatically and periodically reversing said motor according to preset rotation periods of said tool in one direction and in the opposite one, respectively.

2. The dental handpiece according to claim 1, wherein said preset rotation periods are each and independently selected in the range of 0.05 to 2.50 sec.

3. The dental handpiece according to claim 2, wherein said preset rotation periods are selected between values spaced by 0.1 sec.

4. The dental handpiece according to claim 1, wherein said control means constantly scan a start/stop key or pedal acting on the power supply to said motor, thereby the reciprocating operation of said motor can be stopped by an operator at any time.

5. The dental handpiece according to claim 1 or 2, further comprising means for detecting the load torque applied to said tool so that, if load torque detection means are enabled, the control means reverse said motor when the detected torque reaches a preset reference value, said handpiece also comprising means for emitting an acoustic signal triggered by said control means when said detected load torque enters a neighborhood of said preset reference torque.

6. The dental handpiece according to claim 5, wherein the extent of said neighborhood is established as a function of the detected load torque and of the growth rate of the same.

7. The dental handpiece according to claim 6, in which said acoustic signal has different characteristics as a function of the lesser or greater steadiness of said detected load torque within said neighborhood.

8. The dental handpiece according to claim 7, wherein said acoustic signal is an intermittent signal the frequency of which is higher the steadier said detected load torque stays within said neighborhood.

9. The dental handpiece according to claim 5, further comprising means for detecting the rotation speed of said torque so that if the speed detection means are enabled said control means controlling said motor also in response to a signal emitted by said speed detection means, said control means comprising a CPU and actuating means placed between said CPU and said motor, said actuating means comprising a MOSFET bridge controlled by said CPU via PWM signals.

10. The dental handpiece according to claim 10, wherein said motor is placed between four legs of said MOSFET bridge, so that the current flows through the same motor one way or the other as a function of said PWM signals.

11. The dental handpiece according to claim 10, wherein said MOSFET bridge comprises upper legs, controlled by PWM signals for the reciprocating operation of the motor, and lower legs, earthed via a low-value resistor from which a feedback signal for the load torque detection means is obtained.
